(19) United States
(12) Patent Application Publication
(10) Pub. No.: US 2013/0044778 A1
(43) Pub. Date: Feb. 21, 2013

(54) OPTICAL SOURCES HAVING A CAVITY-MATCHED EXTERNAL CAVITY

(71) Applicants: Jacques Gollier, Painted Post, NY (US); Dmitri Vladislavovich Kuksenkov, Big Flats, NY (US)

(72) Inventors: Jacques Gollier, Painted Post, NY (US); Dmitri Vladislavovich Kuksenkov, Big Flats, NY (US)

(21) Appl. No.: 13/212,713

(22) Filed: Aug. 18, 2011

(51) Int. Cl. H01S 3/10; H01S 3/081; H01S 3/08

(52) U.S. Cl. 372/38.02; 372/92; 372/93

(57) ABSTRACT

An optical source including a laser source and a waveguide is provided. The laser source includes a laser cavity having a laser optical path length extending from a DBR grating to a reflective laser output facet, and emits an output beam at a fundamental wavelength. The waveguide includes an input facet and an output face. The waveguide extends along a waveguide optical length from the input facet of the waveguide to the output facet of the waveguide, and the waveguide is optically coupled to the laser source, thereby forming an external cavity having an optical path length extending from the reflective laser output facet to the input facet of the waveguide that is substantially equal to the laser optical path length.

### BACKGROUND

1. Field

Embodiments of the present disclosure generally relate to optical sources and, more particularly, optical sources comprising frequency-converted laser sources having a coupled external cavity for optical feedback control.

2. Summary

Although the various concepts of the present disclosure are not limited to lasers that operate in any particular part of the optical spectrum, reference is frequently made herein to frequency-doubled green lasers, where wavelength fluctuations of the diode IR source typically generate fluctuations of the frequency-converted green output power. Such fluctuations are often attributable to the relatively narrow spectral acceptance curve of the wavelength conversion device used in the frequency-converted laser—typically a periodically poled lithium niobate (PPLN) SHG crystal. If the aforementioned frequency-converted laser is used in a scanning projector, for example, the power fluctuations can generate unacceptable image artifacts. For the specific case when the laser comprises a two or three-section DBR laser, the laser cavity is defined by a relatively high reflectivity Bragg mirror on one side of the laser chip and a relatively low reflectivity coating on the other side of the laser chip. The resulting round-trip loss curve for such a configuration is proportional to the inverse of the spectral reflectivity curve of the Bragg mirror. Also, only a discrete number of wavelengths called cavity modes can be selected by the laser. As the chip is operated, its temperature and therefore the refractive index of the semiconductor material changes, shifting the cavity modes relative to the Bragg reflection curve. As soon as the currently dominant cavity mode moves too far from the peak of the Bragg reflection curve, the laser switches to the mode that is closest to the peak of the Bragg reflection curve since this mode corresponds to the lowest loss—a phenomenon known as mode hopping.

Mode hopping can create sudden changes in output power and will often create visible borders between slightly lighter and slightly darker areas of a projected image because mode hops tend to occur at specific locations within the projected image. Sometimes, a laser will continue to emit in a specific cavity mode even when it moves away from the Bragg reflection peak by more than one free spectral range (mode spacing)—a phenomenon likely related to spatial hole burning and electron-photon dynamics in the cavity. This results in a mode hop of two or more cavity mode spacings and a corresponding unacceptably large change in output power.

Optical feedback from the SHG crystal may create laser wavelength instability in the DBR laser. One method to limit the effect of optical feedback may be to wedge the input and/or output facets of the SHG crystal such that the beam produced by the DBR laser is not perpendicular to the input and/or output facets. However, the wedged facets may need to be orientated at a certain angle with respect to the optical axis of the system, which may add mechanical design constraints as symmetric designs may be desired to obtain increased stability. Even when the facets are wedged at a large angle, the present inventors have recognized that parasitic reflections from the SHG front facet may significantly affect the laser wavelength stability. According to the subject matter of the present disclosure, configurations and corresponding methods of operation are provided to address these and other types of power variations in frequency-converted optical sources.

In accordance with one embodiment, an optical source includes a laser source and a waveguide. The laser source includes a laser cavity having a laser optical path length extending from a DBR grating to a reflective laser output facet, and emits an output beam at a fundamental wavelength. The waveguide includes an input facet and an output face. The waveguide extends along a waveguide optical length from the input facet of the waveguide to the output facet of the waveguide, and the waveguide is optically coupled to the laser source, thereby forming an external cavity having an optical path length extending from the reflective laser output facet to the input facet of the waveguide that is substantially equal to the laser optical path length.

In accordance with another embodiment, an optical source includes a laser source, a wavelength conversion device, and coupling optics. The laser source includes a laser cavity having a laser optical path length extending from a DBR grating to a reflective laser output facet, and emits an output beam at a fundamental wavelength. The wavelength conversion device includes an input facet, an output facet, and a waveguide extending from the input facet of the wavelength conversion device to the output facet of the wavelength conversion device. The input facet and the output facet of the wavelength conversion device are angled with respect to a plane normal to the optical path of the output beam emitted from the output facet of the laser source such that less than about 2.5% of the output beam is reflected back into the laser source from the input facet and the output facet of the wavelength conversion device. The wavelength conversion device is optically coupled to the laser source, thereby forming an external cavity having an optical path length extending from the reflective laser output facet to the input facet of the wavelength conversion device that is substantially equal to the laser optical path length. The coupling optics includes a lens component and a reflective component, and directs the output beam toward the input facet of the wavelength conversion device such that the optical path of the output beam within the external cavity is a folded optical path. The wavelength conversion device converts the output beam emitted by the laser source into a frequency-converted output beam having a converted wavelength that is shorter than the fundamental wavelength.

In accordance with yet another embodiment, an optical source includes a laser source and a wavelength conversion device. The laser source includes a laser cavity having a laser optical path length extending from a DBR grating to a reflective laser output facet, and emits an output beam at a fundamental wavelength. The wavelength conversion device includes an input facet, an output facet, and a waveguide extending from the input facet of the wavelength conversion device to the output facet of the wavelength conversion device. The input facet and the output facet of the wavelength conversion device are normal with respect to the optical path of the output beam at the reflective laser output facet. The wavelength conversion device is optically coupled to the laser source, thereby forming an external cavity having an optical path length extending from the reflective laser output facet to the input facet of the wavelength conversion device that is substantially equal to the laser optical path length. A length of the wavelength conversion device is such that an optical path length between the laser output facet and the output facet of the wavelength conversion device is not an integer multiple of the laser optical path length within the laser cavity. An input facet reflectivity of the input facet of the wavelength conversion device is less than an output facet reflectivity of the reflective laser output facet of the laser source. The wavelength conversion device converts the output beam emitted by the laser source into a frequency-converted output beam having a converted wavelength that is shorter than the fundamental wavelength.

### BRIEF DESCRIPTION OF THE DRAWINGS

FIG. 1 is a schematic illustration of an optical source comprising a DBR laser diode and a wavelength conversion device that define an external cavity according to one or more embodiments of the present disclosure;

FIG. 2 illustrates a round trip extended cavity spectral reflection curve of a laser system in a non-cavity matched condition;

FIG. 3 illustrates a round trip extended cavity spectral reflection curve of an optical source in a cavity matching condition according to one or more embodiments of the present disclosure;

FIG. 4 is a plot of the wavelength standard deviation versus IR wavelength as the gain current increased for a cavity matching condition and non-cavity matching conditions;

FIG. 5 is a schematic illustration of an optical source comprising a DBR laser diode and a wavelength conversion device with wedged facets that define an external cavity according to one or more embodiments of the present disclosure;

FIG. 6 is a schematic illustration of an optical source comprising a DBR laser diode and a wavelength conversion device with wedged facets that define a folded external cavity according to one or more embodiments of the present disclosure;

FIG. 7 illustrates a round trip extended cavity spectral reflection curve of an optical source in a non-cavity matching condition according to one or more embodiments of the present disclosure;

FIG. 8 is a plot of the wavelength of the extended cavity mode with the highest round trip reflectivity as a function of the diode cavity resonance shift according to one or more embodiments of the present disclosure;

FIG. 9 is a schematic illustration of an optical source comprising a DBR laser diode and a wavelength conversion device that define an external cavity in a non-cavity matching condition according to one or more embodiments of the present disclosure; and

FIG. 10 is a schematic illustration of an optical source comprising a DBR laser diode and a wavelength conversion device having two selectable waveguides according to one or more embodiments of the present disclosure.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts.

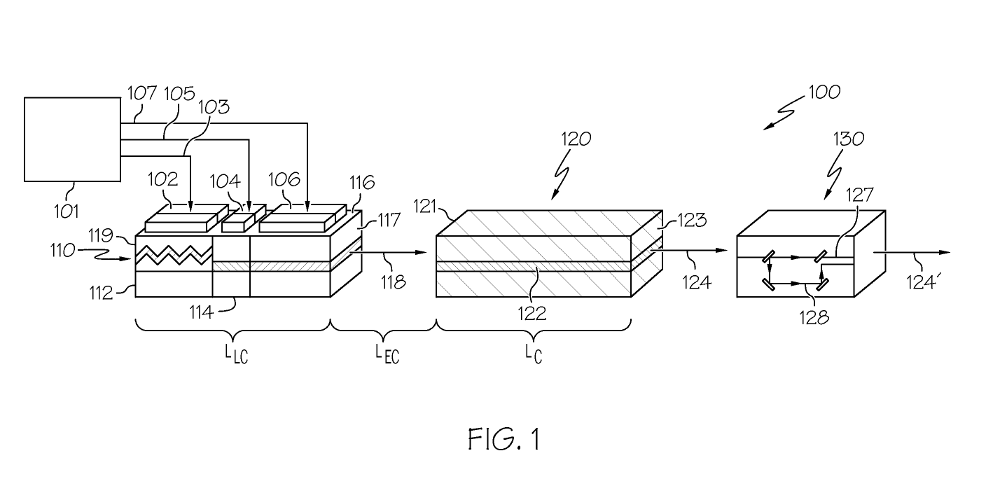

Referring initially to FIG. 1, according to one embodiment of the present disclosure, an optical source 100 comprises a laser cavity presented in the form of a DBR laser diode 110, and a wavelength conversion device presented as a waveguide PPLN crystal 120. Although the present disclosure discusses the particular case where the optical source 100 comprises a laser source configured as a three-section DBR laser diode 110, which is used as an IR pump source, and a waveguide PPLN crystal 120, which is used for frequency doubling into the green wavelength range, it is noted that the concepts of the present disclosure are equally applicable to a variety of frequency-converted laser configurations including, but not limited to, configurations that utilize frequency conversion beyond second harmonic generation (SHG). The concepts of the present disclosure are also applicable to a variety of applications in addition to laser scanning projectors.

The DBR laser diode 110 defines a laser cavity comprising a gain section 116, a phase section 114, and a wavelength selective DBR section 112 interposed between a relatively high reflectivity rear laser facet 119 and a relatively low reflectivity laser output facet 117 at the output of the DBR laser diode 110. The laser cavity defined by the DBR laser diode 110 provides an optical path length L_{LC} of light propagating therein, which is the effective laser cavity length. It should be understood that throughout the figures the optical path length L_{LC} of the laser cavity is labeled as the length of the DBR laser diode 110 for illustrative purposes only, and that the optical path length L_{LC} of the laser cavity is the optical distance of light traveling therein, and may or may not be equal to the physical length of the DBR laser diode 110, and also may be altered by the control signals to the DBR laser diode 110.

Respective control electrodes 102, 104, 106, may be incorporated in the wavelength selective DBR section 112, the phase section 114, the gain section 116, or combinations thereof, and are merely illustrated schematically in FIG. 1. The control electrodes may be electrically coupled to a laser controller 101, which may be configured to provide a wavelength selective modulation signal 103, a phase modulation signal 105, and a gain modulation signal 107 to the wavelength selective section 112, the phase section 114, and the gain section 116, respectively. The controller 101 may comprise any number of hardware and software components to generate the modulation signals 103, 105, 107. It is contemplated that the control electrodes 102, 104, 106 may take a variety of forms. For example, the control electrodes 102, 104, 106 are illustrated in FIG. 1 as respective electrode pairs but it is contemplated that single electrode elements 102, 104, 106 in one or more of the sections 112, 114, 116 will also be suitable for practicing particular embodiments of the present disclosure. The control electrodes 102, 104, 106 can be used to inject electrical current into the corresponding sections 112, 114, 116 of the DBR laser diode 110. The injected current can be used to alter the operating properties of the laser by, for example, controlling the temperature of one or more of the laser sections, injecting electrical current into a conductively doped semiconductor region defined in the laser substrate, controlling the index of refraction of the wavelength selective DBR and phase sections 112, 114 of the DBR laser diode 110, controlling optical gain in the gain section 116, etc.

In one embodiment, the wavelength conversion device 120 comprises an SHG crystal having a frequency-converting waveguide 122 that extends from an input facet 121 to an output facet 123. As illustrated in FIG. 1, the input facet 121 of the wavelength conversion device 120 is optically coupled to the DBR laser diode 110. The waveguide 122 may be periodically poled to achieve quasi-phase matching to frequency-double an IR output beam 118 emitted by the DBR laser diode 110. A frequency-converted output beam 124, which has a converted wavelength that is shorter than the wavelength of the IR output beam 118, is then emitted from the output facet 123 of the wavelength conversion device 120. In one embodiment, the frequency-converted output beam 124 has a wavelength that is in the green spectral range.

Although the waveguide 122 is illustrated as being a component of an SHG crystal, embodiments are not limited thereto. For example, the waveguide 122 may be incorporated into an optical fiber or other optical component.

The input facet 121 and/or output facet 123 of the wavelength conversion device 120 may be reflective such that portions of the IR beam emitted by the DBR laser diode 110 are reflected back into the laser. The input facet 121 and/or the output facet 123 of the wavelength conversion device may define an external cavity that may function as a Fabry-Perot cavity having an optical path length L_{EC} extending from the reflective laser output facet 117 to the input facet 121 or the output facet 123 of the wavelength conversion device, depending on the reflectivity of the input and output facets 121, 123 of the wavelength conversion device 120.

As described in more detail below, a polarization scrambling unit 130 may be optically coupled to the wavelength conversion device 120 to scramble the polarization of the frequency-converted output beam 124 to further reduce the appearance of artifacts in a scanned laser image produced at least in part by the optical source 100.

A portion of the light from the laser cavity of the DBR laser diode 110 is emitted through the laser output face 117 and coupled to the wavelength conversion device 120, while the remaining light bounces back and forth in the laser cavity between the DBR grating, which acts as a mirror, and the laser output facet 117, each time passing through the gain medium of the gain section 116. Additionally, back reflections of light may be reflected from the input facet 121 and or the output facet 123 of the wavelength conversion device and re-enter the laser cavity. These back reflections may cause wavelength instability of the DBR laser diode 110, as well as the resulting frequency-converted output beam 124 emitted from the wavelength conversion device 120.

As described above, the cavity of a DBR laser may be closed by the grating of the wavelength selective DBR section on one side and the reflectivity of the laser output facet on the other side. The round-trip spectral gain curve may be expressed as:

RTG(λ)=G·DBR(λ)·R_{ff},

where RTG(λ) is the round-trip gain, G is the gain section gain coefficient, and R_{ff} is the laser front facet reflectivity. To determine the wavelength selected by the laser, the cavity modes may be calculated. The cavity modes of the laser diode are the wavelengths where the optical path over a round trip with in the laser cavity equals an integer times the wavelength. The cavity modes are calculated by determining the wavelengths that can create standing waves, i.e. wavelengths where there is a round trip light wave phase change of 2π. The wavelength emitted by the DBR laser diode is then given by the cavity mode that is closest to the RTG spectral curve. The wavelength difference between the various modes may be expressed as:

$$Δλ = \frac{{λ}^{2}}{2 \cdot L \cdot n} ,$$

where L is the laser diode length, and n is the index of refraction of gallium arsenide (GaAs).

As an example and not a limitation, with a laser cavity physical length of 3 mm, mode spacing is about 0.06 nm. The expectation is then that the maximum wavelength fluctuations should be about ±0.03 nm, which would result in frequency-converted power fluctuations of about 4% when assuming a 0.24 bandwidth PPLN crystal as the wavelength conversion device. However, the present inventors have recognized that measured power fluctuations are much larger, and experimental results suggest that part of the wavelength fluctuations is due to instabilities induced by parasitic reflections on the input facet and/or output facet of the wavelength conversion device.

In one experiment, which consisted of generating variable amounts of back reflection from a wavelength conversion device and applying increasing gain current, about −110 dB of feedback resulted in a DBR laser diode that operated normally. The level of feedback was increased from about −110 dB to about −3 dB of back reflections. At −70 dB, some abnormal mode hops were discovered at low current. At −40 dB, abnormal mode hops were spread everywhere throughout the current range. The mode hop structure appeared to disappear at −18 dB and was replaced by smoother transitions. Finally, at −3 dB of feedback, the normal expected curve shape of the IR wavelength was totally disturbed and very large amplitude wavelength variations were evident. Accordingly, back reflections into the laser cavity may increase wavelength instability.

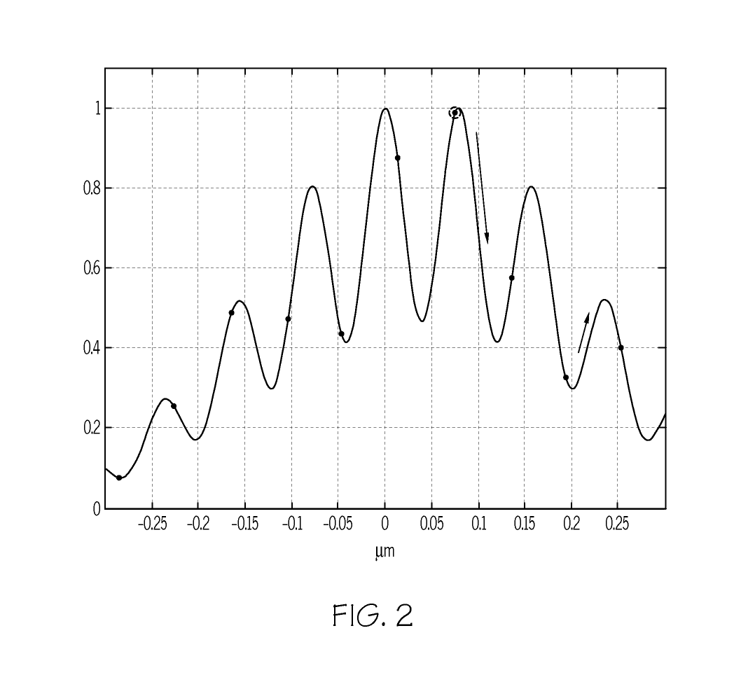

FIG. 2 graphically illustrates one example of a round trip extended cavity spectral reflection curve. For completeness, it is noted that the curve of FIG. 2 has been normalized such that the maximum reflection is equal to 1.0. Referring additionally to FIG. 1, it is noted that the curve of FIG. 2 was obtained using a wavelength selective DBR section 112 having a full width half maximum (FWHM) spectral bandwidth of 0.6 nm, an external reflector reflectivity of 2.5% (e.g., an input facet of a wavelength conversion device), a laser cavity length of 3 mm, and an extended cavity length between the laser output facet 117 and the external reflector of 7 mm. The points on the curve correspond to particular cavity modes. In the case where the external mirror has a reflection coefficient smaller than the laser output facet, it may be shown that the mode spacing remains close to the mode without the external reflector. In the optical source depicted in FIG. 1, the external reflector may be considered as the input facet 121 of the waveguide 122. Additionally, the period of the modulation is dictated by the distance between the laser output facet 117 and the external mirror defined by the input facet 121 of the waveguide 122. When that distance is different from the laser round trip optical path, the mode spacing and the modulation period are both different.

As illustrated in FIG. 2, the encircled point corresponds to the mode currently selected by the DBR laser diode. When the effective length of the laser cavity is changed by modulating the gain signal, the curve in FIG. 2 will stay in place. However, as the DBR laser diode heats up due to gain current modulation, the cavity modes shift to the right. The selected mode may rapidly fall in a minimum of modulation to the closest cavity mode as indicated by the arrows. The points in the figure may move up or move down the sloping portions of the curve. Another mode located far way from the maximum of the DBR curve can move towards a maximum of the modulation and be selected although it is located far away from the DBR maximum. In the illustrated case, the amplitude of the wavelength fluctuations can end up being much larger than ±0.03 nm.

Additionally, the modulation frequency increases as the distance of the external reflective surface from the DBR laser diode increases. The consequence is that the DBR laser diode may become unstable and start mode hopping very often. Accordingly, simulations and experimentation suggest that feedback as low as 0.01% may be enough to create laser instabilities. Even with wedged and anti-reflective (AR) coated crystals, such reflectivity levels may be difficult to achieve.

The present inventors have recognized that when the external reflective surface (e.g., the input facet 121 of the wavelength conversion device 120 depicted in FIG. 1) is substantially the same as the optical path of the laser cavity (i.e., a cavity matching condition), the period of the gain curve modulation is substantially the same as the cavity mode inter-distance.

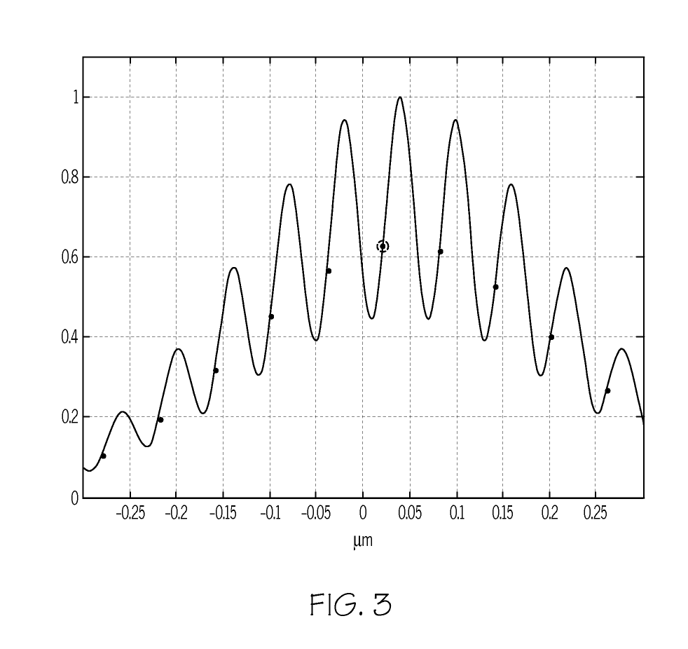

FIG. 3 depicts a graph illustrating the round trip extended cavity spectral reflection curve of an optical source according to one embodiment wherein the DBR laser diode 110 and the input facet 121 of the wavelength conversion device 120 is in a cavity matching condition (see FIG. 1). As with FIG. 2, the points in the graph represent cavity modes, with the encircled point being the currently selected cavity mode. The modulation of the gain curve due to injection of gain current and/or heating of the DBR laser diode 110 does not affect the relative gains between the modes. In other words, when the modes are moving, they are all located at substantially the same position on the modulation and the curve that is joining the points has the same shape as the DBR curve alone. Accordingly, the modes are going to be selected exactly like there was no external cavity presented at all. Therefore, when the laser cavity and the external cavity defined by the laser output facet and the input facet of the wavelength conversion device are matched, wavelength instabilities may be eliminated even when the input facet of the wavelength conversion device has significant reflectivity coefficients. As an example and not a limitation, the DBR laser diode 110 in one embodiment experiences sequential mode hops having an average amplitude of less than about 0.5 nm during lasing operation.

Referring again to FIG. 1, to obtain cavity matching conditions, the length of the external cavity L_{EC} should be an integer multiple of the optical path length of the laser cavity L_{LC}. Therefore, the wavelength conversion device 120 should be positioned with respect to the DBR laser diode 110 to achieve this condition. The tolerance on the cavity matching condition may be a function of many parameters. According to one embodiment, as an example and not a limitation, the external cavity length L_{EC} is within 0.2 mm assuming a 2.5% laser reflectivity, a 0.6 nm DBR bandwidth and a 9.4 mm external cavity length.

Additionally, when the external laser cavity is formed of multiple mirrors, such as when both the input facet 121 and the output facet 123 of the wavelength conversion device 120 present back reflections, the mirror with the highest reflectivity should be the one that is farthest away from the DBR laser diode 110. Accordingly, when the output facet 123 of the wavelength conversion device provides back reflections, its reflectivity should be greater than the reflectivity of the input facet 121. The cavity mode spacing being mostly determined by the dominating mirror, choosing the highest reflectivity of the farthest mirror may result in decreasing the mode spacing, thereby reducing the amplitude of the mode hops.

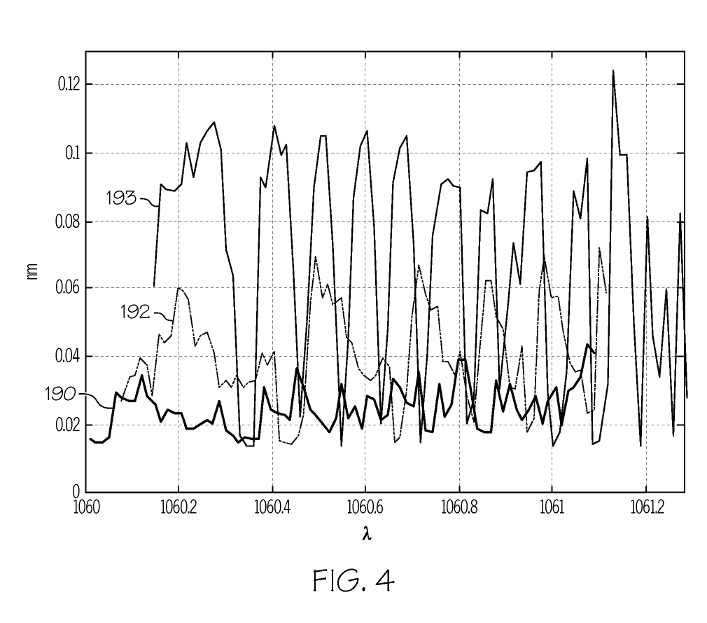

Referring now to FIG. 4, the cavity matching effect was experimentally verified. The experiment included coupling a 1060 nm DBR laser diode to a fiber that had no wedge at the input facet (i.e., a straight input facet) so as to introduce 4% feedback into the laser. The external cavity length was adjusted by coupling the fiber to a reflectometer measuring the distance between the fiber input facet and the DBR laser diode output facet. The laser stability was determined by measuring the spectral width as the DBR laser diode was modulated under a fast return-to-zero (RZ) modulation scheme and received gradually increasing average gain current. Curve 190 depicts the result when the external cavity was aligned for the cavity matching condition (L=9.36 mm), curve 192 depicts the result when the external cavity was misaligned from the cavity matching condition by about 150 microns, and curve 194 depicts the result when the external cavity has the same length as from the laser diode to an input facet of the PPLN crystal in a Corning G1000 laser package. As may be seen from the results provided in FIG. 4, the standard deviation in the cavity matching condition (curve 190) remains smaller than when the cavities are not matched.

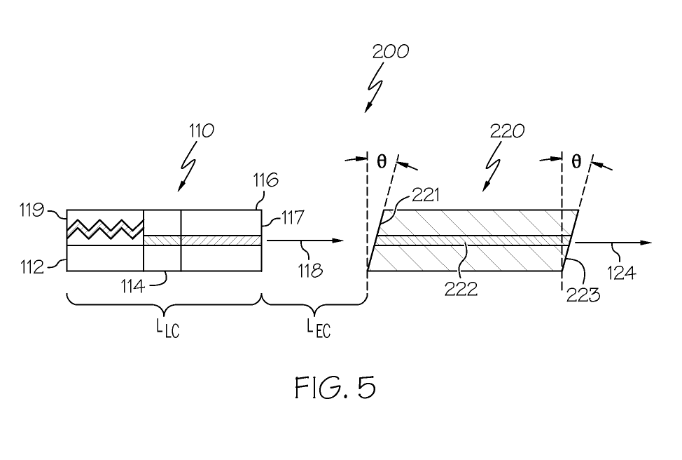

FIG. 5 schematically depicts an optical source 200 wherein the input facet 221 and the output facet 223 of the wavelength conversion device are angled by a wedge angle θ with respect to a plane that is normal to the optical path of the IR output beam emitted by the DBR laser diode 110. The wedge angle θ may be an angle that reduces the amount of back-reflections from the wavelength conversion device. In one embodiment, the wedged angle θ is such that less than about 2.5% of the IR output beam is reflected back into the DBR laser diode 110. As an example and not a limitation, the wedged angle θ may be about 10 degrees on both the input facet 221 and the output facet 223. In an alternative embodiment, either the input facet 221 or the output facet 223 may be angled.

The wavelength conversion device 220 is positioned with respect to the DBR laser diode 110 such that an external cavity between the reflective laser output facet 117 and the input facet 221 has an optical path length L_{EC} that is substantially equal to the laser optical path length L_{LC} within the laser cavity such that the laser cavity and the external cavity are in the cavity matching condition. Anti-reflective coating may be optionally applied to the input facet 221 and/or the output facet 223 of the wavelength conversion device 220 to further reduce back reflections.

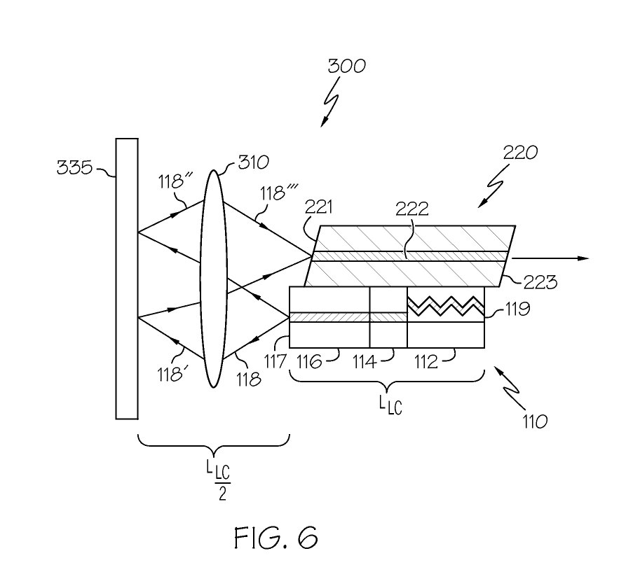

Because the cavity matching condition may require a relatively large distance between the DBR laser diode 110 and the wavelength conversion device 220, coupling optics may be utilized to create a folded optical path within the external cavity. FIG. 6 schematically illustrates an optical source 300 comprising a wedged wavelength conversion device 220 and a folded optical path within the external cavity. In the illustrated embodiment, coupling optics include a lens component 310 and a reflective component 335 that create a folded optical path. The IR output beam 118 is focused by the lens component 210 and directed toward the reflective component 335 as focused output beam 118′. The focused output beam 118′ is then reflected back toward the lens component 310 as illustrated by reflected output beam 118″, where it is then focused as coupled output beam 118′″ such that it is incident on the wedged input facet 221 at the waveguide 222 of the wavelength conversion device 220. The total optical path distance of the output beam between the reflective laser output facet 117 and the input facet 221 (the external optical cavity optical path length L_{EC}) may be substantially equal to the laser optical path length L_{LC} within the laser cavity. In one embodiment, the optical path length from the reflective laser output facet 117 to the reflective component 335 is about one-half of the laser optical path length L_{LC} within the laser cavity. The input and output facets of the wavelength conversion device may also be coated with an anti-reflective coating. It should be understood that wavelength conversion devices having straight input and output facets may be coupled to the DBR laser diode by a folded optical path.

In an alternative embodiment, the external reflective surface(s) of the wavelength conversion device may be positioned relative to the DBR laser diode and configured such that the laser cavity and the external cavity are not in a cavity matching condition to encourage very fast mode hops that occur at a frequency that is greater than the average response time of the human eye. When the mode hops occur at a frequency that is greater than the average response time of the human eye, the observer will not notice the artifacts in the image despite large amplitude wavelength variations due to the large amplitude mode hops. In other words, the eye will average the wavelength variations such that the artifacts are substantially unnoticeable to the observer.

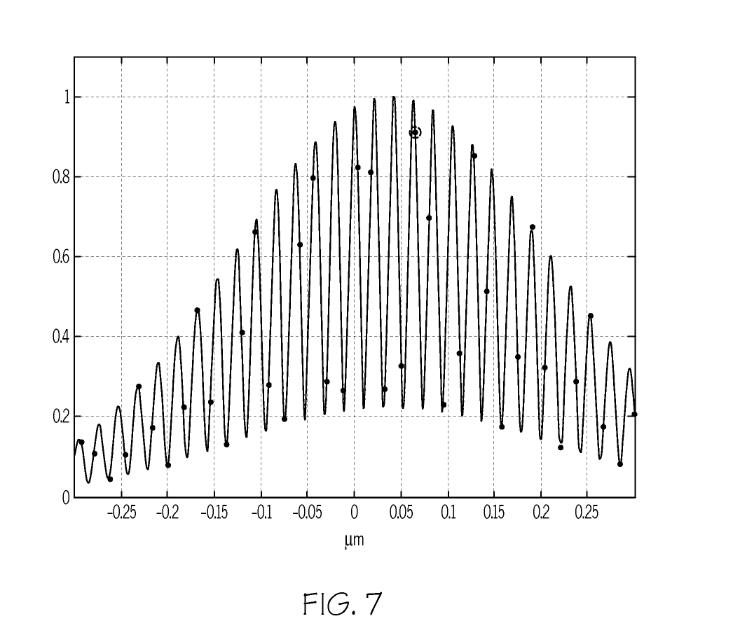

FIG. 7 depicts a graph illustrating the round trip extended cavity spectral reflection curve of an optical source according to one embodiment wherein the external feedback is stronger than the laser output facet. The graph of FIG. 7 shows the gain curve and the mode position assuming a 15% external reflector (e.g., a reflective facet of the wavelength conversion device) and an external cavity length of 27 nm. As illustrated in FIGS. 2 and 3, the points in the graph represent cavity modes, with the encircled point being the currently selected cavity mode. The cavity is dominated by the feedback and the mode spacing is mostly dictated by the length of the external cavity plus the laser optical path within the laser cavity. Accordingly, as depicted in FIG. 7 and compared with FIG. 3, the density of the modes may dramatically increase, thereby causing the DBR laser diode to mode-hop very rapidly.

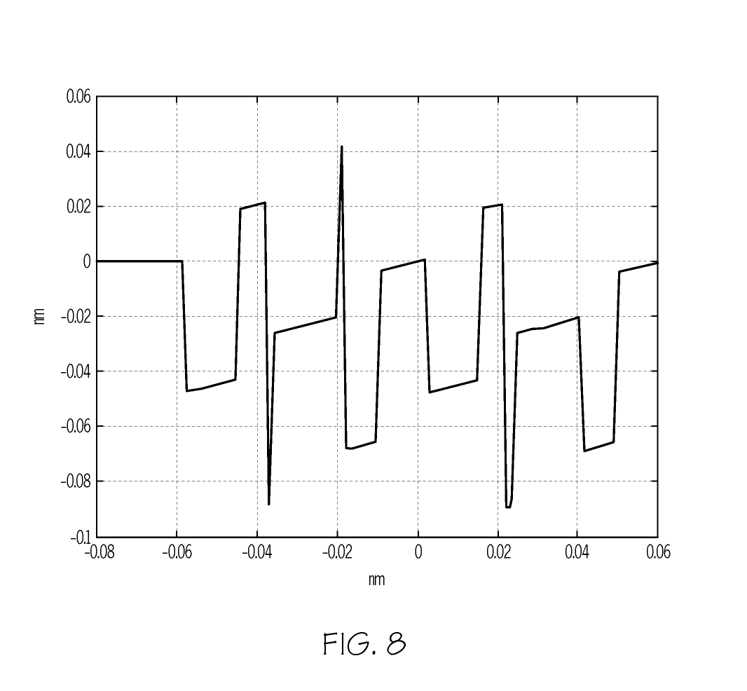

FIG. 8 depicts a plot of the wavelength of the optical source with an extended cavity mode as described above with the highest round trip reflectivity (lowest loss) as a function of the laser cavity resonance shift. Assuming, for simplicity, that a mode hop takes place immediately after a new extended cavity mode becomes the lowest loss mode, the chart represents the evolution of the output wavelength of such a laser diode. In reality, the originally-selected low loss mode can persist longer than illustrated, even after it is no longer the low loss mode, due to phenomena such as spatial hole burning and photo-electron dynamics. FIG. 8 shows that the modes are moving by 0.12 nm, and that the laser diode makes many small amplitude mode hops.

Further, as the cavity modes are moving, the reflectivity of the Fabry-Perot mirror defined by the laser output facet and the reflective facet of the wavelength conversion device is constantly changing between high and low reflectivity. Because the reflectivity of the equivalent mirror that closes the external cavity is constantly varying, the photon density inside of the laser cavity is also changing, which results in mode self modulation. The laser diode may be constantly jumping between different modes at a high speed.

To further encourage fast mode hops, the phase section may be modulated with a phase modulation signal such that the operating mode can move quickly down the effective reflectivity curve and force the laser to select a new operating mode before departing significantly from the Bragg reflection peak. As such, the new mode will be very close in wavelength to the original mode, and will rarely be further away than one free spectral range of the laser cavity without an external mirror. Accordingly, even though the phase control signal is modulated to instigate mode hopping, the operating wavelength will remain close to the Bragg reflection peak and only small changes in the output power of the wavelength conversion device. Similarly, a gain modulation signal may be provided to the gain section and/or a wavelength selective modulation signal to the wavelength selective section to encourage fast mode hops. The wavelength selective modulation signal frequency should be greater than the gain modulation signal frequency such that the wavelength fluctuations occur rapidly. Various modulation signal techniques are described in U.S. Pat. Pub. No. 2010/0254412 entitled “Phase Modulation in a Frequency-Converted Laser Source Comprising an External Optical Feedback Component.”

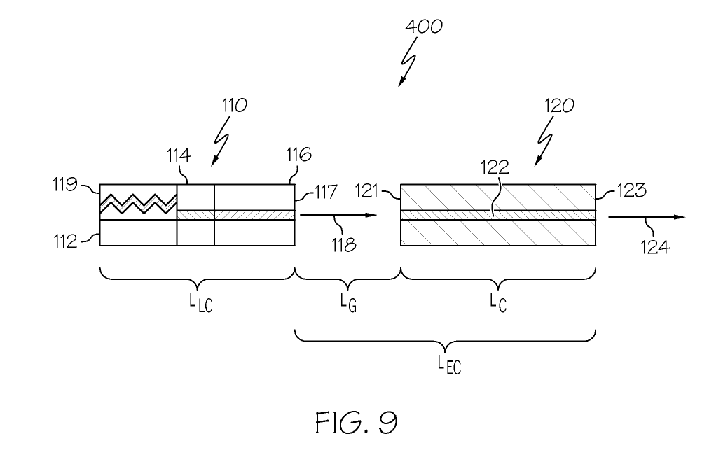

Referring now to FIG. 9, an optical source 400 configured to encourage fast mode hopping is illustrated. The optical source 400 comprises a DBR laser diode 110 as described above, and a wavelength conversion device 120 having a straight input facet 121 and a straight output facet 123 to increase reflectivity and form an external cavity. The input facet 121 may be coated with an anti-reflectivity coating (or otherwise treated for anti-reflective properties) and the distance L_{G} from the input facet 121 to the laser output facet 117 may be set to equal the laser optical path length L_{LC} within the laser cavity. The length of the wavelength conversion device 120 is such that the output facet 123 is not an integer-multiple of the laser optical path length L_{LC} within the laser cavity (i.e., not in a cavity matching condition). The output facet 123 of the wavelength conversion device 120 may coated, or otherwise prepared, to reflect more of the IR output beam 118 than the input facet 121. In one embodiment, the input facet 121 is coated to reflect less than about 0.3% of the IR output beam 118 and the output facet 123 is coated to reflect about 15% of the IR output beam 118. It should be understood that other reflectivity ratios may be utilized.

Because the output facet 123 acts as the dominant external mirror, an external cavity having an optical path length L_{EC} is positioned between the laser output facet 117 and the output facet 123. As described above, the length of the wavelength conversion device 120 is such that the optical path length L_{EC} of the external cavity is not in a cavity matching condition with respect to the laser optical path length L_{LC} within the laser cavity to encourage fast mode hopping that occurs faster than the average response time of the human eye. The phase section or the gain section may be modulated with modulation signals as described above to further encourage fast mode hop fluctuations.

In one embodiment, the external cavity may be folded as illustrated in FIG. 6 to reduce the overall package length of the optical source 400.

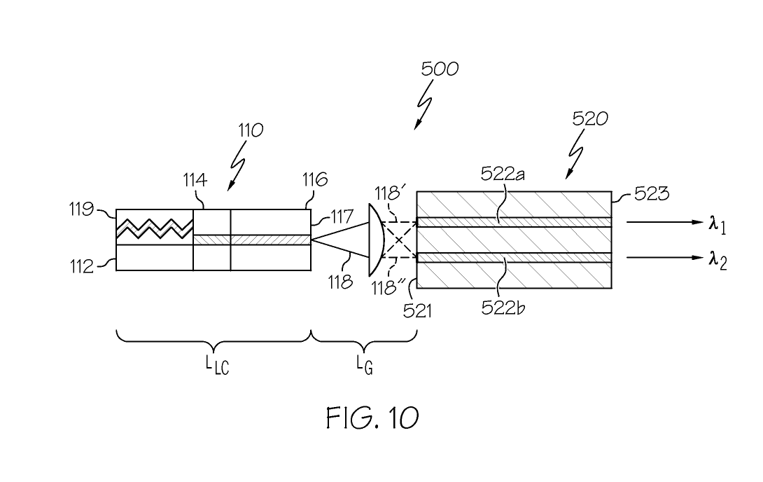

Referring now to FIG. 10, another optical source 500 configuration is illustrated. The wavelength conversion device 520 has straight input and output facets 521 and 523 with reflectivities as described above (the input facet 521 has a reflectivity that is less than the output facet 523) and the wavelength conversion device 520 has a length such that the output facet 523 is not in a cavity matching condition. As shown in FIG. 10, the wavelength conversion device has two waveguides: a first waveguide portion 522a and a second waveguide portion 522b that are positioned side by side and centered over two different wavelengths. The waveguide portions may be stacked vertically as shown in FIG. 10 or in different arrangements, such as on the same horizontal plane, for example.

The optical source 500 further comprises a waveguide selective actuator 511 that is configured to sequentially couple the IR output beam 118 into either the first or second waveguide portion 522a, 522b. The waveguide selective actuator 511 may be any device or assembly capable of directing the IR output beam 118 into the first and second waveguide portion 522a, 522b. In one embodiment, the waveguide selective actuator 511 may be a microelectromechanical systems (MEMS) actuated prism or lens that may be controlled to direct the output beam as indicated by output beams 118′ and 118″. Actuated mirrors or reflective surfaces may also be utilized to sequentially direct the IR output beam 118 into the first and second waveguide portions 522a, 522b. The first waveguide portion 522a is configured to frequency-double a directed IR output beam 118′ to a first frequency-converted wavelength λ₁, and the second waveguide portion 522b is configured to frequency-double the IR output beam 118″ to a second frequency-converted wavelength λ₁. The first frequency-converted wavelength λ₁ is separated from the second frequency-converted wavelength λ₂ by Δλ such that the appearance of speckle caused by constructive and deconstructive interference of the frequency-converted output beam 124 may be reduced by about \sqrt{2}. Accordingly, such an optical source may reduce both artifacts caused by wavelength fluctuations due to mode hopping as well as artifacts caused by speckle. It is noted that a controller may also provide modulation signals to the wavelength selective, phase, and/or gain sections 112, 114, 116 to cause fast mode hopping.

Additional speckle-reducing techniques may also be utilized in conjunction with the external cavity configurations described above. For example and referring once again to FIG. 1, a polarization scrambler unit 130 may be optically coupled to the wavelength conversion devices to further reduce the appearance of speckle by about \sqrt{2} via fast polarization scrambling. In one embodiment, the polarization scrambler unit 130 may transform wavelength fluctuations of the frequency-converted output beam 124 into polarization scrambling that may reduce the appearance of speckle. For example, the DBR laser diode 110 may be modulated by a modulation signal, such as the gain and/or phase modulations described above, to modulate the DBR laser diode 110 such that it emits an IR output beam 118 having a changing wavelength. As described above, mode hops may cause the DBR laser diode 110 to emit an output beam having a fluctuation wavelength, which may cause the wavelength of the frequency-converted output beam 124 to also fluctuate.

In one embodiment, the polarization scrambler unit 130 may be configured as a polarization split and delay unit as described in U.S. Pat. No. 7,653,097, entitled “Systems and Methods for Polarization Modulation of an Optical Signal.” It should be understood that other polarization modulators may be utilized. The polarizing split and delay unit 130 is configured to split a frequency-converted output beam 124 that rapidly oscillates or switches between two output wavelengths (a first wavelength λ₁ and a second wavelength λ₂) into two components with equal power and orthogonal polarization, delay one of the components by a predetermined amount to create an optical path length difference ΔL, and combine both components to create a combined frequency-converted output beam 124′. Orthogonal polarization is not limited to light polarized at 90 degrees, or linear polarization. Polarizations are orthogonal where the two polarization states do not interfere with one another. For example, left hand and right hand circular polarizations are orthogonal polarizations. To optimally reduce speckle, as discussed herein, the optical path length difference ΔL and the wavelength difference Δλ between the first wavelength λ₁ and the second wavelength λ₂ should be large enough so that the two polarization beams oscillate between an in-phase state and an out of phase state so that the frequency-converted output beam 124 also oscillates between two orthogonal states. In phase may be defined as the components having a phase difference of approximately an even integer multiple of π. Conversely, out of phase may be defined as the components having a phase difference of approximately an odd integer multiple of π.

The polarizing split and delay unit 130 may comprise one or more polarizing beam that may be used to split the frequency-converted output beam 124 into two beams with orthogonal polarization (a first orthogonally polarized component and a second orthogonally polarized component). One specific example of a polarizing beam splitter is a Glan-Taylor prism, which typically comprises two right-angled prisms of calcite (or other similar birefringent material) that are separated on their long faces with an air gap, with the optical axes of the calcite crystals aligned parallel to the plane of reflection. The component of the incoming frequency-converted output beam 124 with the electrical field vector parallel to the plane of incidence/reflection (known as p-polarization) is transmitted through the polarizing beam splitter, and the component with the electrical field vector perpendicular to the plane of incidence/reflection (known as s-polarization) experiences total internal reflection and is deflected at a right angle. If a frequency-converted output beam 124 is polarized at 45 degrees to the plane of incidence/reflection, it will be split into an approximately equal power orthogonally polarized p and s components, one transmitted and the other reflected.

For example, an s-polarized component 127 may be reflected from the polarizing beam splitter and immediately exit the polarizing split and delay unit 130. A p-polarized component 128 may experience reflections within the polarizing split and delay unit 130 then be transmitted through the beam splitter and combined with the s-polarized component 127 to form a combined frequency-converted output beam 124′, thereby producing an optical path length difference ΔL between the s and p components 127, 128. The resulting polarization scrambling of the combined frequency converted output beam 124′ may result in a reduction in the appearance of speckle.

The wavelength of the frequency-converted output beam 124 may be modulated by a variety of means. In one embodiment, the phase and/or gain sections 114, 116 may be modulated by a modulation signal as described above to produce the above-described wavelength fluctuations. Other wavelength modulation techniques may also be utilized.

It is to be understood that the preceding detailed description is intended to provide an overview or framework for understanding the nature and character of the subject matter as it is claimed. It will be apparent to those skilled in the art that various modifications and variations can be made to the embodiments described herein without departing from the spirit and scope of the invention. Thus, it is intended that the present invention cover the modifications and variations of this invention provided they come within the scope of the appended claims and their equivalents.

It is noted that terms like “preferably,” and “typically,” when utilized herein, are not intended to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Further, it is noted that reference to a value, parameter, or variable being a “function of” another value, parameter, or variable should not be taken to mean that the value, parameter, or variable is a function of one and only one value, parameter, or variable.

For the purposes of describing and defining the present invention it is noted that the terms “substantially,” “approximately” and “about” are utilized herein to represent the inherent degree of uncertainty that may be attributed to any quantitative comparison, value, measurement, or other representation. The term “substantially” is also utilized herein to represent the degree by which a quantitative representation. e.g., “substantially above zero,” varies from a stated reference, e.g., “zero,” and should be interpreted to require that the quantitative representation varies from the stated reference by a readily discernable amount.

What is claimed is:

1. An optical source comprising a laser source and a waveguide, wherein:
the laser source comprises a laser cavity having a laser optical path length extending from a DBR grating to a reflective laser output facet, and the laser source emits an output beam at a fundamental wavelength;
the waveguide comprises an input facet and an output facet, the waveguide extending along a waveguide optical length from the input facet of the waveguide to the output facet of the waveguide; and
the waveguide is optically coupled to the laser source, thereby forming an external cavity having an optical path length extending from the reflective laser output facet to the input facet of the waveguide that is substantially equal to the laser optical path length.

2. The optical source of claim 1, wherein the waveguide comprises a frequency-converting waveguide of a wavelength conversion device that converts the output beam emitted by the laser source into a frequency-converted output beam having a converted wavelength that is shorter than the fundamental wavelength.

3. The optical source of claim 1, wherein the input facet and the output facet of the waveguide are angled with respect to an optical path of the output beam emitted from the output facet of the laser source.

4. The optical source of claim 3 further comprising a lens component and a reflective component, wherein the lens component and the reflective component are configured to direct the output beam toward the input facet of the waveguide such that an optical path of the output beam within the external cavity is a folded optical path.

5. The optical source of claim 3, wherein an angle of the input facet and an angle of the output facet of the waveguide are such that less than about 2.5% of the output beam is reflected back into the laser source from the input facet and the output facet of the waveguide.

6. The optical source of claim 3, wherein the input facet and the output facet of the waveguide are angled at about ten degrees with respect to the optical path of the output beam emitted from the output facet of the laser source.

7. The optical source of claim 3, wherein the optical path length of the external cavity is within about 0.2 mm of the laser optical path length within the laser cavity of the laser source.

8. The optical source of claim 3, wherein the output beam of the laser source experiences sequential mode hops having an average amplitude of less than about 0.5 nm during lasing.

9. The optical source of claim 1, wherein:
the input facet and the output facet of the waveguide are normal with respect to an optical path of the output beam at the reflective laser output facet; and
a length of the waveguide is such that an optical path length between the reflective laser output facet and the output facet of the waveguide is not an integer multiple of the laser optical path length within the laser cavity.

10. The optical source of claim 9 further comprising a lens component and a reflective component, wherein the lens component and the reflective component are configured to direct the output beam toward the input facet of the waveguide such that an optical path of the output beam within the external cavity is a folded optical path.

11. The optical source of claim 9, wherein an input facet reflectivity of the input facet of the waveguide is less than an output facet reflectivity of the reflective laser output facet of the laser source.

12. The optical source of claim 11, wherein the input facet reflectivity of the input facet of the waveguide is less than about 0.3% of the output beam and the output facet reflectivity of the reflective laser output facet of the laser source is about 15% of the output beam.

13. The optical source of claim 9, wherein the output beam of the laser source experiences sequential mode hops at a frequency that is greater than an average response time of the eye.

14. The optical source of claim 9, wherein:
the optical source further comprises a laser controller coupled to the laser source;
the laser cavity comprises a gain section, a wavelength selective section, and a phase section; and
the laser controller is programmed to provide a gain modulation signal to the gain section, a phase modulation signal to the phase section, a wavelength selective modulation signal to the wavelength selective section, or combinations thereof, such that the laser source experiences mode hops at a frequency that is greater than an average response time of the eye.

15. The optical source of claim 14, wherein a wavelength selective modulation signal frequency of the wavelength selective modulation signal is greater than a gain modulation signal frequency of the gain modulation signal.

16. The optical source of claim 14, wherein:
the optical source further comprises a polarization split and delay unit optically coupled to the output facet of the waveguide;
the polarization split and delay unit receives a frequency-converted output beam from the output facet of the waveguide and is configured to:
split the frequency-converted output beam into a first orthogonally polarized component and a second orthogonally polarized component;
create an optical path length difference ΔL between the first and second orthogonally polarized components; and
combine the first and second orthogonally polarized components into a combined frequency-converted output beam;
the laser controller is programmed to instruct the laser controller to modulate the output beam by applying a wavelength modulation signal to the laser source such that a modulated frequency-converted output beam comprises at least a first wavelength λ₁ and a second wavelength λ₂ such that the first wavelength λ₁ and the second wavelength λ₂ are separated by a wavelength difference Δλ, and the wavelength difference Δλ and the optical path length difference ΔL are such that the first orthogonally polarized component and the second orthogonally polarized component oscillate back and forth from an in-phase state, where the first and second orthogonally polarized components are approximately in phase, to an out of phase state, where the first and second orthogonally polarized components are approximately out of phase.

17. The optical source of claim 9, wherein:
the optical source comprises a waveguide selective actuator;
the waveguide comprises a first waveguide portion and a second waveguide portion that is separated from the first waveguide portion;
the first waveguide portion frequency-converts the output beam such that a frequency-converted output beam exiting the waveguide from the first waveguide portion has a first frequency-converted wavelength;
the second waveguide portion frequency-converts the output beam such that the frequency-converted output beam exiting the waveguide from the second waveguide portion has a second frequency-converted wavelength; and
the first frequency-converted wavelength is separated from the second frequency-converted wavelength by Δλ.

18. The optical source of claim 17, wherein:
the optical source further comprises a laser controller electrically coupled to the laser source;
the laser cavity comprises a gain section, a wavelength selective section, and a phase section; and
the laser controller is programmed to provide a gain modulation signal to the gain section, a phase modulation signal to the phase section, or combinations thereof, such that the laser source experiences mode hops at a frequency that is greater than an average response time of the eye.

19. An optical source comprising a laser source, a wavelength conversion device, and coupling optics, wherein:
the laser source comprises a laser cavity having a laser optical path length extending from a DBR grating to a reflective laser output facet, and the laser source emits an output beam at a fundamental wavelength;
the wavelength conversion device comprises an input facet, an output facet, and a waveguide extending from the input facet of the wavelength conversion device to the output facet of the wavelength conversion device;
the input facet and the output facet of the wavelength conversion device are angled with respect to an optical path of the output beam emitted from the output facet of the laser source such that less than about 2.5% of the output beam is reflected back into the laser source from the input facet and the output facet of the wavelength conversion device;
the wavelength conversion device is optically coupled to the laser source, thereby forming an external cavity having an optical path length extending from the reflective laser output facet to the input facet of the wavelength conversion device that is substantially equal to the laser optical path length;
the coupling optics comprises a lens component and a reflective component, and directs the output beam toward the input facet of the wavelength conversion device such that the optical path of the output beam within the external cavity is a folded optical path; and
the wavelength conversion device converts the output beam emitted by the laser source into a frequency-converted output beam having a converted wavelength that is shorter than the fundamental wavelength.

20. An optical source comprising a laser source and a wavelength conversion device, wherein:
the laser source comprises a laser cavity having a laser optical path length extending from a DBR grating to a reflective laser output facet, and the laser source emits an output beam at a fundamental wavelength;
the wavelength conversion device comprises an input facet, an output facet, and a waveguide extending from the input facet of the wavelength conversion device to the output facet of the wavelength conversion device;
the input facet and the output facet of the wavelength conversion device are normal with respect to the optical path of the output beam at the reflective laser output facet;
the wavelength conversion device is optically coupled to the laser source, thereby forming an external cavity having an optical path length extending from the reflective laser output facet to the input facet of the wavelength conversion device that is substantially equal to the laser optical path length;
a length of the wavelength conversion device is such that an optical path length between the reflective laser output facet and the output facet of the wavelength conversion device is not an integer multiple of the laser optical path length within the laser cavity;
an input facet reflectivity of the input facet of the wavelength conversion device is less than an output facet reflectivity of the reflective laser output facet of the laser source; and
the wavelength conversion device converts the output beam emitted by the laser source into a frequency-converted output beam having a converted wavelength that is shorter than the fundamental wavelength.
